(19) United States
(12) Patent Application Publication
(10) Pub. No.: US 2007/0077445 A1
(43) Pub. Date: Apr. 5, 2007

(54) Panel containing bamboo and fungicide

(76) Inventor: Eric N. Lawson, Hull, GA (US)

Correspondence Address: Carlos Nieves, Esq.;J. M. Huber Corporation, 333 Thornall Street, Edison, NJ, 08837-2220, US

(21) Appl. No.: 11/240,067

(22) Filed: Sep. 30, 2005

(51) Int. Cl. B32B 21/04

(52) U.S. Cl. 428/537.1

(57) ABSTRACT

Disclosed is a panel comprising bamboo strands and a boron compound fungicide.

### BACKGROUND OF THE INVENTION

Bamboo is a lignocellulosic material widely used throughout Asia as a building material because of its high strength, durability and excellent dimensional stability, as well as its ready supply and rapid replenishment—bamboo grows very rapidly, reaching full maturity within 2 to 6 years, while even the fastest growing wood tree species take as long as 15 to 30 years to grow to full maturity.

However, while bamboo has these advantages, it also has certain disadvantages, for example bamboo is particularly susceptible to fungus. Fungus, the most widely-known examples of which are brown rot decay fungus (gloeophyllum trabeum) and white rot fungus (trametes versicolor), actively decomposes lignocellulosic material utilizing the natural components of wood such as carbon and energy sources.

Bamboo's susceptibility to fungal attack arises from two separate characteristics that are peculiar to bamboo. First, bamboo's growth is very episodic, being concentrated entirely within a single growing season lasting between 30 to 90 days. In order to make this rapid growth possible, bamboo stores far more starch in its tissues than conventional softwood or hardwood tree species do. This high starch content makes bamboo particularly vulnerable to fungal attack. Bamboo is also susceptible to fungal attack because it has no known metabolite deposition of anti-fungal compounds such as the polyphenols that are deposited in hardwood and softwood, and thus bamboo does not increase in fungal attack resistance with age, as most trees do.

A variety of techniques have been developed to address the issue of fungus and rot in lignocellulosic materials. For example, bamboo can be smoked to prevent such destruction, but this process is labor-intensive and not consistently successful. Another technique, pressure-treating, has met with some, limited success. However, recently many of the most effective pressure-treating chemicals have been removed from the market because they are deemed a potential environmental hazard, and those pressure-treating chemicals that are deemed safe are, unfortunately, significantly less effective at resisting pests.

An alternative to these pressure-treating chemicals is sodium borate solutions, which have been proven efficacious at resisting pests. Additionally sodium borate solutions are not overly labor and time intensive because they are water soluble and can easily wick into the bamboo material when a freshly cut stem is inserted into a sodium borate solution. However, while in the aforementioned respect the water solubility is an advantage, the water solubility also presents certain difficulties, such as the fact that the sodium borate solution dissolves out of the bamboo when the bamboo is contacted with water.

Given the foregoing, there is a need in the art for a bamboo composite panel containing a water-insoluble fungicide that imparts a resistance to insect and fungus infestations without the use of toxic or potentially harmful chemicals.

### BRIEF SUMMARY OF THE INVENTION

The present invention includes a panel containing bamboo strands and a boron compound fungicide.

### DETAILED DESCRIPTION OF THE INVENTION

All parts, percentages and ratios used herein are expressed by weight unless otherwise specified. All documents cited herein are incorporated by reference.

As used herein, “lignocellulosic material” is intended to mean a cellular structure, having cell walls composed of cellulose and hemicellulose fibers bonded together by lignin polymer. Wood is a species of lignocellulosic material.

By “wood composite material” or “wood composite component” it is meant a composite material that comprises lignocellulosic material and one or more other additives, such as adhesives or waxes. Non-limiting examples of wood composite materials include structural composite lumber (“SCL”), waferboard, particle board, chipboard, medium-density fiberboard, plywood, and boards that are a composite of strands and ply veneers. As used herein, “flakes”, “strands”, and “wafers” are considered equivalent to one another and are used interchangeably. A non-exclusive description of wood composite materials may be found in the Supplement Volume to the Kirk-Othmer Encyclopedia of Chemical Technology, pp 765-810, 6^{th} Edition, which is hereby incorporated by reference.

The following describes preferred embodiments of the present invention, which provides a composite panel comprising bamboo strands an a boron compound fungicide. The bamboo composite panel is prepared by adding a boron compound fungicide during the blending and mixing stages (discussed in greater detail below) so that the fungicide fully penetrates into the strands. Zinc borate has shown itself to be effective not only against fungus like white and brown rot, but also against insects like termites. Moreover zinc borate is water-insoluble, which means that it not only does not bleed out of bamboo when the bamboo is contacted by water, but also means that the zinc borate is compatible with a wider range of resins (discussed below) than water-insoluble fungicides.

The boron compounds used in the present invention are particulates, preferably small enough to pass through a 30 size mesh screen. Zinc borate is the preferred boron compound but also acceptable are more general anhydrous borax compounds. The boron compound is preferably used at a concentration of about 0.25 wt % to about 1.25 wt %.

Like other wood materials, bamboo's basic components are cellulose fibers bonded together by lignin polymer, but bamboo differs from other wood materials in the organization and morphology of its constituent cells. Generally, most strength characteristics of bamboo (tensile strength, flexural strength and rigidity) are greatest in the longitudinal direction of the bamboo and the bamboo fibers. This is due to the relatively small micro-fibrillar angle of the cellulose fibers in the longitudinal direction. The hardness of the bamboo culm itself is dependent on the density of bamboo fibers bundles and their manner of separation. The percentage of fibers does not consist either in the longitudinal direction of the bamboo culm or in a cross section of the culm. In the longitudinal direction, the density of fibers increases from the bottom of the culm to its top, while the density of fibers in the bamboo culm cross-section is highest closer to the outer surface and decreases going deeper into the core of the material.

In the present invention the bamboo strands are preferably cut into thicknesses of less than about 0.2 inch, such as less than 0.15 inches, such as in the range of about 0.01 inches to about 0.15 inches; and cut into widths of preferably greater than about 0.1 inches, such as more than about 0.15 inches, such as more than about 0.5 inches. This cutting may be done either manually or with mechanized clipping equipment. For purposes of improved strength the bamboo strands should be cut along the longitudinal axis into strands preferably longer than about 2 inches, such as about 3 inches, such as about 5 inches. While not intending to be limited by theory, it is believed that the longer strip length will result in more closely aligned strands when the strands are oriented using a disk strand orienter, and without being limited by theory, it is believed that more closely aligned strands will result in a final wood composite board product that has an improved modulus of elasticity along the longitudinal axis.

After being cut, the bamboo strands are dried (as described below) and coated with isocyanate polymeric resin. The binder concentration of the isocyante resin is in the range of about 2 wt % to about 12 wt %, based on the dry weight of the bamboo. One or more isocyanate binder resins may be used, preferably the isocyanates are selected from the diphenylmethane-p,p′-diisocyanate group of polymers, which have NCO- functional groups that can react with other organic groups to form polymer groups such as polyurea, —NCON—, and polyurethane, —NCOON—; a binder with about 50 wt % 4,4-diphenyl-methane diisocyanate (“MDI”) or in a mixture with other isocyanate oligomers (“pMDI”) is preferred. A suitable commercial pMDI product is Rubinate 1840 available from Huntsman, Salt Lake City, Utah, and Mondur 541 available from Bayer Corporation, North America, of Pittsburgh, Pa. Also suitable for use are phenol formaldehyde (“PF”), melamine formaldehyde, melamine urea formaldehyde (“MUF”) and the co-polymers thereof. Suitable commercial MUF binders are the LS 2358 and LS 2250 products from the Dynea corporation.

A wax additive is commonly employed to enhance the resistance of the bamboo strands to moisture penetration. Preferred waxes are slack wax or an emulsion wax. The wax solids loading level is preferably in the range of about 0.1 wt % to about 3.0 wt % (based on the weight of the bamboo).

As used in the present invention the bamboo is formed into strand composite lumber panels, preferably OSB panels. The panels may be made entirely from bamboo strands, or instead the bamboo strands may be mixed with naturally occurring hard or soft woods, singularly or mixed, whether such wood is dry (having a moisture content of between 2 wt % and 12 wt %) or green (having a moisture content of between 30 wt % and 200 wt %). Typically, the raw wood starting materials, either virgin or reclaimed, are cut into strands, wafers or flakes of desired size and shape, which are well known to one of ordinary skill in the art. When the panels are made from a combination of both the bamboo strands and naturally occurring hard or soft woods, the two separate sets of woods are separately dried and coated with polymer resin binder, and then after the separate coating stages the coated hard/soft wood strands and coated bamboo strands are admixed together.

After the strands are cut they are dried in an oven and then coated with a special formulation of an isocyanate polymeric binder resin, waxes, the boron compound fungicide (zinc borate being especially preferred), and possibly other additives. The binder resin and the other various additives that are applied to the wood materials are referred to herein as a coating, even though the binder and additives may be in the form of small particles, such as atomized particles or solid particles, which do not form a continuous coating upon the wood material. Conventionally, the binder, wax, fungicide, and any other additives are applied to the wood materials by one or more spraying, blending or mixing techniques, a preferred technique is to spray the wax, resin, fungicide and other additives upon the wood strands as the strands are tumbled in a drum blender.

After being coated and treated with the desired coating and treatment chemicals, these coated strands are used to form a multi-layered mat, preferably a three layered mat which is then pressed to form a composite wood component. This layering may be done in the following fashion. The coated flakes are spread on a conveyor belt to provide a first ply or layer having flakes oriented substantially in line, or parallel, to the conveyor belt, then a second ply is deposited on the first ply, with the flakes of the second ply oriented substantially perpendicular to the conveyor belt. Finally, a third ply having flakes oriented substantially in line with the conveyor belt, similar to the first ply, is deposited on the second ply such that plies built-up in this manner have flakes oriented generally perpendicular to a neighboring ply. Alternatively, but less preferably, all plies can have strands oriented in random directions. The multiple plies or layers can be deposited using generally known multi-pass techniques and strand orienter equipment. In the case of a three ply or three layered mat, the first and third plys are surface layers, while the second ply is a core layer. The surface layers each have an exterior face.

The above example may also be done in different relative directions, so that the first ply has flakes oriented substantially perpendicular to conveyor belt, then a second ply is deposited on the first ply, with the flakes of the second ply oriented substantially parallel to the conveyor belt. In the present invention, the longitudinal edge of the board is formed parallel to the conveyor belt, so that flakes oriented substantially parallel to the conveyor belt will be oriented substantially arranged substantially parallel to the conveyor belt, will end up being substantially parallel to the longitudinal edge of the final wood panel product. Finally, a third ply having flakes oriented substantially perpendicular with the conveyor belt, similar to the first ply, is deposited on the second ply.

As discussed above, an important part of the present invention is the use of isocyanate binder resins with the bamboo strands. However, as with conventional pine, aspen or the like wood strands, conventional polymeric binder resins commonly used with wood composites may be used. These resins include urea-formaldehyde, polyvinyl acetate (“PVA”), phenol formaldehyde, melamine formaldehyde, melamine urea formaldehyde (“MUF”), the isocyantes mentioned and the co-polymers thereof.

After the multi-layered mats are formed according to the process discussed above, they are compressed under a hot press machine that fuses and binds together the wood materials, binder, and other additives to form consolidated OSB panels of various thickness and sizes. The high temperature also acts to cure the binder material. Preferably, the panels of the invention are pressed for 2-15 minutes at a temperature of about 175° C. to about 240° C. The thickness of the OSB panels will be from about 0.6 cm (about ¼″) to about 5 cm (about 2″), such as about 1.25 cm to about 6 cm, such as about 2.8 cm to about 3.8 cm.

### EXAMPLES

OSB Panels having a target thickness of ¾″ and a target density of 46 pcf were prepared with Mondur G541 pMDI resin at a concentration of 5 wt % (based on the weight of the wood flakes), wax at a concentration of 2.5 wt %, and with zinc borate added during blending at concentrations of 0.0 wt %, 0.25 wt %, 0.5 wt %, 1 wt % and 1.25 wt % (again based on the weight of the wood flakes).

Cubes were then cut from these panels and then tested for fungal resistance according to the test WDMA/NWWDA TM 1 test protocol. In this test, the OSB samples were exposed to the brown rot decay fungus (Gloeophyllum trabeum) and the white rot fungus (Trametes versicolor) under ideal fungal growing conditions for twelve days. Before testing, some of the cubes were “weathered” according to Window and Door Standard NWWDA-TM-1 (“Soil Block Test”), while others were not weathered. After exposure is completed the samples are removed and are weighed to determine the percentage of weight loss due to decay. The amount of weight loss is set forth in table I below.

TABLE I

| % Zinc Borate | Fungus Type | Weathered | % Weight loss |
|---|---|---|---|
| 0.0 | brown | Y | 21.28 |
| 0.25 | brown | Y | 6.60 |
| 0.5 | brown | Y | 2.19 |
| 0.75 | brown | Y | 1.99 |
| 1.0 | brown | Y | 2.66 |
| 1.25 | brown | Y | 2.74 |
| 0.0 | brown | N | 17.24 |
| 0.25 | brown | N | 5.53 |
| 0.5 | brown | N | 2.32 |
| 0.75 | brown | N | 1.91 |
| 1.0 | brown | N | 3.1 |
| 1.25 | brown | N | 2.31 |
| 0.0 | white | Y | 25.9 |
| 0.25 | white | Y | 2.56 |
| 0.5 | white | Y | 3.38 |
| 0.75 | white | Y | 3.13 |
| 1.0 | white | Y | 3.6 |
| 1.25 | white | Y | 2.84 |
| 0.0 | white | N | 34.06 |
| 0.25 | white | N | 2.35 |
| 0.5 | white | N | 1.37 |
| 0.75 | white | N | 1.38 |
| 1.0 | white | N | 2.9 |
| 1.25 | white | N | 2.4 |

As can be seen in table I, the amount of bamboo lost to rot declined dramatically when zinc borate was included in the bamboo panel as described in the present invention. This indicates zinc borates provided excellent fungicide performance.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A panel comprising bamboo strands and a boron compound fungicide.

2. The panel according to claim 1, wherein the boron compound fungicide is zinc borate.

3. The panel according to claim 1, wherein the boron compound fungicide is present in a concentration range of about 0.25 wt % to about 1.25 wt %.

4. The panel according to claim 1, further comprising an isocyante binder resin.

5. The panel according to claim 1, wherein the strands have a thickness of less than about 0.2 inch, such as about 0.01 inches to about 0.15 inches.

6. The panel according to claim 1, wherein the strands have a width of greater than about 0.1 inches.

7. The panel according to claim 4, wherein the isocyante binder resin is MDI.

8. A panel comprising bamboo strands, about 0.25 wt % to about 1.25 wt % of zinc borate, and an isocyante binder resin.
